(19) United States
(12) Patent Application Publication
(10) Pub. No.: US 2026/0357583 A1
(43) Pub. Date: Nov. 12, 2026

(54) METHOD FOR MANUFACTURING PANELS; AND PANELS OBTAINED BY THIS METHOD

(71) Applicant: UNILIN, BV, Wielsbeke (BE)

(72) Inventors: Martin SEGAERT, Wielsbeke (BE); Milan THOEN, Wielsbeke (BE); Pieter-Jan SABBE, Wielsbeke (BE)

(21) Appl. No.: 19/135,640

(22) PCT Filed: Dec. 14, 2023
(86) PCT No.: PCT/IB2023/062679

§ 371 Date: Jun. 4, 2025

Related U.S. Application Data
(60) Provisional application No. 63/387,795, filed on Dec. 16, 2022.

(51) Int. Cl. E04F 15/10; E04F 15/02

(52) U.S. Cl. CPC E04F 15/105; E04F 15/02038; E04F 2201/023; E04F 2201/042; E04F 2201/043

(57) ABSTRACT

A method for manufacturing panels includes a substrate and a top layer. The panels are provided with a first pair and a second pair of opposite edges, with at least the first pair of opposite edges are profiled to form profiled edges that include coupling parts. The profiled edges undergo a plasma treatment to apply material to them. During this treatment, the profiled edges are exposed to plasma containing at least hydrophobic molecules and a carrier gas. The plasma is applied to the profiled edges, attaching the hydrophobic molecules to them.

The present invention relates to a method for manufacturing panels; and to panels—for example floor panels—obtained by these methods.

In particular, the invention relates to panels used to compose, for example, a floating floor covering. Such floor panels are for example known from WO 97/47834 and may be provided with profiled edge areas on two opposite side edges which include milled coupling means fitting together which allow two such floor panels to be coupled together at the respective side edges, preferably without the use of glue. Potentially, the coupling means may be executed with some pre-tensioning, which means that the contour of the coupling means is made to some extent overlapping in such a way that, in a coupled condition, a tension originates which pushes the panels towards each other. Such pre-tensioning is interesting to counteract the formation of gaps after laying. This can also limit the penetration of dust and moisture. In some cases, the milling quality of the coupling means is insufficient to keep the seams permanently watertight. In addition, at the corner points of such panels there is an increased sensitivity to water intrusion. At the corners, the profiled edges of adjacent side edges intersect, and because of this it is possible that the milled coupling means may be absent or insufficient.

In the case of panels with a moisture-sensitive substrate and/or top layer, such as a substrate based on MDF or HDF (medium or high density fiberboard), the penetration of moisture into the seams of a floor covering composed of panels can lead to swellings and/or discolorations that becomes disturbingly visible on the decorative surface of such panels. Moreover, such swellings of the substrate in themselves can lead to accelerated wear of the floor surface. Furthermore, the penetration of moisture into the seams of a floor covering is problematic in itself, even if neither the substrate nor the top layer is moisture sensitive. In such a case, water may collect under the floor covering and this can give rise to the formation of mold and its associated unpleasantness.

From WO 2008/078181 it is known to treat the side edges of a floor panel with an MDF or HDF substrate with a water-repellent substance that includes a fluorinated polymer or copolymer. The substance in question is applied to the side edge of the floor panel by means of a so-called vaccumate, e.g. of the type known from the DE 92 02 976 U1. The starting and stopping of such a vaccumate respectively at the entry and exit of the side edge from the vaccumate is difficult to fine-tune and may cause the angular points of the relevant side edge to be insufficiently covered with the relevant water-repellent substance.

The invention also relates to panels, such as floor panels, comprising a polymer substrate. Such panels are seen as waterproof panels, however these panels are sensitive to mold formation due to water/moisture. Floor elements comprising a polymer substrate and provided with coupling means along their sides are known, for example from WO 2018/087637. Such floor panels are deemed to be waterproof. The coupling means are, for example, so-called click-fit systems, tongue-and-groove systems or so-called “fold down” systems. These coupling means are intended to keep adjacent floor elements coupled together. However, the joint which is brought about by means of the prior-art coupling means may be water-permeable. This may result in water ending up under the floor covering which is composed of such floor panels and eventually to fungal growth.

The coupling means of the floor elements known from WO'637 may lead to defects or other undesirable effects in the floor covering composed of such floor elements when they are subjected to changing thermal conditions, for example if the floor is partly or completely exposed to the sun, which causes the temperature of the floor, i.e. of the floor elements which are coupled together, to rise. The dimensional changes of the floor elements may result in a section of the floor being raised, connections between floor elements becoming detached and/or the formation of gaps between floor elements which have been coupled together. These problems may then in turn result in an increased water permeability of the joints.

It is known from CN 107619513 to make such a floor element more resistant to fungal growth by adding fungus-resistant additives to the material from which the floor panel is composed.

It is known from WO 2016/182896 to treat the edges of water-sensitive floor panels with an impregnating agent and/or a sealant. Such a treatment prevents any moisture from penetrating into the floor panel.

The current impregnating agents and/or sealants and/or coatings have to be applied correctly, such that they do not form protrusions and/or thick layers which hinder the coupling of panels to each other.

It is an object of the invention to provide alternative floor elements. According to various preferred embodiments, floor elements are provided which offer a solution to one or more of the problems of prior-art floor elements.

The object of the invention is achieved by providing a method for manufacturing panels, wherein the panels are rectangular, either square or oblong, wherein the panels comprise a substrate and a top layer, for example a decorative top layer;
wherein the panels are provided with a first pair and a second pair of opposite edges, of which at least said first pair of opposite edges are profiled to form profiled edges which at least comprise coupling parts, wherein at least one and preferably both of said profiled edges are subjected to a plasma treatment to apply material to said profiled edges, preferably in the form of a film, wherein said plasma treatment exposes said profiled edges to a plasma, wherein the plasma comprises at least hydrophobic molecules and a carrier gas, wherein this plasma is applied to said profiled edges and as such attaches said hydrophobic molecules to said profiled edges. These hydrophobic molecules can be directly and/or indirectly attached to said profiled edges, thus can directly and/or indirectly adhere/adsorb to the surface of said profiled edges. This because, before the profiled edges are exposed to the plasma treatment, a film and/or coating could already have been applied upon the profiled edges. Said hydrophobic molecules provided the profiled edges with water-repellent properties, as such limiting the risk that water/moisture will go into the seams between two such panels which are coupled to each other at the height of corresponding coupling parts. It is possible that another water-repellent coating or film is already applied to the profiled edges before the plasma treatment. The plasma treatment then provides additional water-repellent properties.

The by the plasma treatment applied hydrophobic molecules, preferably form a film. With a film a thin layer is indicated, preferably a layer of at most 10 nanometer, for example a layer of between 0,1 and 5 nanometer. This film could be an uninterrupted film, meaning that there is no or almost no room between different hydrophobic molecules. However, this could also be an open film, with room between different hydrophobic molecules, wherein said hydrophobic molecules are close enough to repel water and thus to prevent water that contacts the panel at the height of a said profiled edge, to go into the seams between two such coupled panels.

Preferably the plasma is formed by bringing together said hydrophobic molecules and said carrier gas, and then bringing them in the plasma state. Here the hydrophobic molecules are bond to said profiled edges and are preferably each separately bonded to said profiled edges. Preferably these hydrophobic molecules do not further react with each other, for example there is no further polymerization between said hydrophobic molecules. With the aid of this plasma treatment the desired hydrophobic molecules are preferably deposited as such upon the profiled edges.

Of course it is also possible to bring molecules and a gas together and bringing them in the plasma state, wherein said molecules form said hydrophobic molecules as a result of the energy of the plasma state. For example use can be made of the technique of plasma-depositing material or plasma polymerization. In plasma polymerization, one may start from mono-or oligomers which are, under the influence of the energy of the plasma, transformed to polymers, which adhere to the plasma-treated surface.

The formation of the plasma state preferably takes place in a treatment region, for example the treatment region of a plasma torch, wherein said plasma is then for example applied upon the profiled edges with the aid of one or more nozzles which eject beams of plasma (plasma beams). These beams can have different shapes and can for example have cross sections, seen perpendicular to the beam eject direction, that are circular, rectangular, etc.

The profiled edges are preferably exposed to the plasma treatment in such a way that hydrophobic molecules get at least bound to the profiled edges near the edge of the top layer, and further preferably also hydrophobic molecules are bound to the edge of the top layer.

The plasma comes into contact with a surface of the profiled edges, and activates said surface, as such that said hydrophobic molecules, which are also activated because of said plasma state, can bind very easily at said profiled edges, preferably at the height of the surface of the profiled edges such that they can repel water that comes into contact with the panels at the height of the profiled edges. This surface of the profiled edges could be directly formed by the substrate and/or the top layer, but a coating or similar could have been applied to a said profiled edge before the plasma treatment, in which then this coating forms the surface of the profiled edge.

The coupling parts on the first pair of opposite edges are preferably configured as overlapping, so that during coupling on the first pair of opposite edges, coupling with pretension is obtained. With the aid of pretension, the seams are even more watertight. The coupling parts preferably comprise locking elements, so that the panel can be coupled on a first edge of a first pair of opposite edges to a second edge of a first pair of opposite edges of another such panel, wherein in the coupled state, locking occurs in the direction perpendicular to the surface of the coupled panels and locking also occurs in the plane of the coupled panels and perpendicular to the coupled edges. This coupling parts may be any kind of coupling parts known from the prior art, for example tongue-and-groove coupling means, coupling means comprising click-fit systems, coupling means comprising fold-down systems, coupling means comprising rotating profiles and the like.

The advantage of the method according to the invention, is that only a small amount of hydrophobic molecules is needed to have the desired effect, namely that the seams between adjacent panels can be kept more watertight. Further because only a small amount is needed, and further preferably because only a thin film is formed, said plasma treatment does not hinder the coupling of said panels. The plasma could only comprise hydrophobic molecules and said carrier gas, this means that not many components are needed to provide the panels with the necessary hydrophobic properties. However a solvent or water and/or additives can be used.

Preferably the hydrophobic molecules are all the same molecules or at least are of the same type, for example all acrylates, polyurethanes, siloxanes, silazanes, linear aliphatic alkanes, branched aliphatic alkanes, etc. However mixtures of different types of hydrophobic molecules are possible.

In a very preferred embodiment the applied plasma has a temperature of at most 100 °C, preferably at most 70 °C and more preferably at most 50 °C. The plasma treatment is thus a cold plasma treatment. Said plasma will not negatively influence the panel. The plasma treatment thus only provides a positive effect, namely seams that are more watertight. No harmful effects are present and the different layers of the panels, for example the substrate and the top layer, keep their strength. It is possible that during the plasma treatment the panel is exposed to one or more plasma beams. Preferably, the plasma treatment does not cause a temperature increase which causes the profiled edges to have a temperature above 60 °C.

Preferably, the applied plasma comprises an inner flow comprising said hydrophobic molecules and said carrier gas and an outer flow surrounding said inner flow, wherein said outer flow comprises a protective gas. With the aid of this outer flow, this inner flow can be well guided in the desired direction and as such towards the profiled edges. With the aid of said inner and outer flow, it is possible to very precisely treat the desired parts of the profiled edges. It is not necessary to treat the entire profiled edges, very good results are obtained when at least the upper region of profiled edges, being the one closest to the top surface of the panel and/or at the height of the top surface of the panel, are treated and have hydrophobic molecules attached to it. This because normally the top surface of the panel will be most likely to get into contact with water, this for example during cleaning and/or when drinks are spilled on it. The outer beam ensures that hydrophobic molecules are shielded from the surrounding area and cannot get lost in the surrounding area such that used hydrophobic molecules as much as possible attach the profiled edges. Further said outer flow ensures an additional activation of the profiled edges, such that the profiled edges which need to receive said hydrophobic molecules are well activated once the hydrophobic molecules make contact with it, as such ensuring a good bond between the profiled edges and the hydrophobic molecules. The protective gas can be the same gas as the carrier gas. However this is not necessary, the protective gas and the carrier gas could not be the same gas and could thus be different gases.

Further preferably the inner flow of the plasma is a beam applied towards and upon the profiled edges according to a direction of movement, wherein said direction of movement is preferably in the plane of the panel, wherein the dimension of said inner flow according to a direction perpendicular to the plane of the panel is at least the same as the height of the part of the profiled edges that needs to be treated. This beam preferably has a substantially constant cross section perpendicular to the direction of movement. At the height of the seams at the top surface of the panels, the profiled edges preferably have edge parts which are perpendicular to the plane of the panels and/or who lie closely against similar edge parts of adjacent panels. When the direction of movement is in the plane of the panel, such edge parts can be well treated by the plasma treatment. The said cross section can have a circular or a rectangular shape.

The carrier gas and/or the protective gas are preferably choses from the list: nitrogen gas (N2), helium gas (He), Argon gas (Ar), oxygen gas (O2), heliox gas or air. Preferably the carrier gas, and the protective gas if present, are nitrogen gas. Nitrogen gas is an inert gas that is not explosive, and is as such highly useable for the plasma treatment.

In a very preferred embodiment the hydrophobic molecules comprise an aliphatic hydrocarbon group with preferably between 6 and 34 carbon atoms, preferably between 8 and 24 carbon atoms. Such aliphatic hydrocarbon groups are hydrophobic. These hydrophobic molecules can be monomers, but can also be polymers. The hydrophobic molecules can be a mixture of different types of hydrophobic molecules, but preferably only comprise one type of hydrophobic molecules and even could comprise only hydrophobic molecules of the same chemical structure. This aliphatic hydrocarbon group will preferably, when the hydrophobic molecule is attached to said profiled edge, direct itself away from the profiled edge and as such enhance the water resistant/water repellent properties of the panel. With the presence of aliphatic hydrocarbon groups, there is no need for fluor atoms. These aliphatic hydrocarbon groups have no negative impact on the environment and human health. They are not persistent in the environment and do not give rise to bioaccumulation. The aliphatic hydrocarbon groups can for example comprise 8, 12, 18 or 22 carbon atoms.

Further preferably, the aliphatic hydrocarbon groups are linear aliphatic hydrocarbon groups which preferably have as formula CₙH₂ₙ₊₁. Such groups will be linearly directed away from the panel when the hydrophobic molecule is attached to said coupled edge. A said hydrophobic molecule can have one, two or more such linear aliphatic hydrocarbon groups which are or are not the same. Other possibilities are branched aliphatic hydrocarbon groups or alicyclic aliphatic hydrocarbon groups.

In a very preferred embodiment the hydrophobic molecules are chosen from the list consisting of: acrylates—such as acrylate esters-, squalene—such as hydrogenated squalene-, siloxanes—such as tetramethyldisiloxane or hexamethyldisiloxane-, polyurethanes, silazanes—such as a polysilazane-, linear aliphatic alkanes or branched aliphatic alkanes, silanes, (modified) alkyd/acryl resins, benzoate esters. The abovementioned hydrophobic molecules are preferably monomers, but can also be polymers. Of course mixtures of monomers and polymers are also possible. These hydrophobic molecules preferably have a said linear aliphatic hydrocarbon group. The hydrophobic molecules comprise or are for example: dodecylacrylate; 1,1,3,3-tetramethyldisiloxane, tetradecylacrylate, pentadecylacrylate or tridecylacrylate. Use can be made of relatively small molecules to enhance the water-repellent properties of profiled edges.

In a very preferred embodiment, with the aid of this plasma treatment, between 1 mg and 50 mg hydrophobic molecules are applied per m² panel, for example at least 10 mg, at least 15 mg and/or for example at most 40 mg, at most 30 mg. The weight of hydrophobic molecules is expressed upon m² panels. Of course the weight will depend upon the measurements of the panels. The smaller the dimensions of the panels, the more meters edges will be present, and the more hydrophobic molecules can be applied. Normally the panels, if the panels are floor panels, have a length of more than 1 m and a width of more than 15 cm.

With the aid of this plasma treatment, preferably between 0,01 and 2 mg hydrophobic molecules are applied per meter coupling parts, preferably at most 1,5 mg, more preferably at most 1 mg.

Preferably the hydrophobic molecules are atomized-preferably in an atomizer-and activated during plasma formation, and wherein the plasma treatment activates the profiled edges at the height of the substrate and/or the top layer, such that the plasma treatment causes a covalent bond between the hydrophobic molecules and the substrate and/or the top layer.

Preferably no solvents are used to form the plasma. For example only the hydrophobic molecules are brought into contact with the carrier gas. No solvents are needed to form said plasma, such that problems resulting from the use of solvents are not present. Of course, water or solvents could be present in alternative embodiments.

In a very preferred embodiment the hydrophobic molecules are free from fluor.

In a preferred embodiment the plasma treatment takes place at atmospheric pressure and is for example done with the aid of a plasma torch, wherein said plasma torch comprises for example a nozzle. By working at atmospheric pressure no adaptions need to be made at the height of the panels. There is for example no need to bring the panels in an area with reduced pressure, such that said plasma treatment can be done in a normal production area, for example can be applied in a continuous line at a location behind milling machines that form the profiled edges. Of course, in an alternative embodiment the plasma treatment could take place a reduced pressure, for example with the aid of a suction device.

In a very preferred embodiment said plasma is applied as one or more flows of plasma, for example plasma beams, and this with the aid of respectively one or more nozzles, and wherein preferably a said nozzle operates in such a way that a said flow of plasma has a direction of movement, wherein at least one said direction of movement is in the plane of the panel and, viewed in the plane of the panel, makes an angle with the profiled edge of 90° or of less than 90°. Preferably the plasma treatment is done with an application device which is stationary while the panel is being moved past the respective nozzle(s). This can be done, for example, in a so-called “double end tenoner” or feed-through milling machine, for example intended to provide profiled edges on the relevant side edge and the opposite side edge. The nozzle(s) in question can then be fixed while the panel in question is moved by means of the feed mechanism present in the milling machine, for example with a conveyor chain and pressure belts. An arrangement in a feed-through milling machine leads to a better and repeatable application quality. In addition, the relevant side edge can be guided in a vertical direction at the location of the application device between so-called sliding and pressure shoes.

Because a said direction of movement is in the plane of the panel, the respective flow of plasma is well suited to treat a said profiled edge. Said direction of movement makes, viewed in the plane of the panel, an angle with the profiled edge of 90° or of less than 90°, for example an angle of between 30° and 85° or an angle of between 40° and 60°. If the angle is less than 90° to the relevant profiled edge, this nozzle can also treat at least partially an adjacent profiled edge of the second pair of opposite edges, including the corner between these edges. If at least two nozzles are present, wherein each nozzle directs a flow of plasma towards a said profiled edge, both nozzles could be positioned in such a way that said flows of plasma, viewed in the plane of the panel, both make an angle of 90° with the profiled edge, or both make an angle of less than 90° with the profiled edge, or one makes an angle of 90° and the other makes an angle of less than 90° with the profiled edge. Also, if the angle is less than 90°, said flow of plasma is less likely to break already existing attachments between hydrophobic molecules and the profiled edge. Further if said flows of plasma make, viewed in the plane of the panel, an angle of less than 90° with the respective profiled edge, said direction of movement can have a component which is opposite to the movement of the aforementioned panel or can have a component which is parallel to the movement of the aforementioned panel and not opposite but in the same direction of the movement of the panel. In this way one can optimize the plasma treatment as desired, taking into account the desired water resistance and the desired cost (for example the amount of plasma torches).

If the panels to be treated are rectangular and if both the first and the second pair of opposite edges are profiled edges that need to be treated, at least two nozzles are needed to treat all the four profiled edges. These are preferably placed at the height of the long edges, for example the first pair of opposite edges, wherein one nozzle is placed on one edge of the first pair of opposite edges, while the other nozzle is placed on the other edge of the first pair of opposite edges. The nozzles are placed in such a way that one said flow of plasma has a direction of movement in the plane of the panel, and viewed in the plane of the panel, has a component which is opposite to the movement of the aforementioned panel and the other has a direction of movement in the plane of the panel, and viewed in the plane of the panel, has a component which is parallel to the movement of the aforementioned panel. In such a way each nozzle treats one profiled edge of the first pair of opposite edges and also one profiled edge of the second pair of opposite edges. Also the corners between the edges are well treated. Of course more nozzles can be used to apply more hydrophobic molecules and/or to assure that all the profiled edges get the desired amount of hydrophobic molecules. Preferably also nozzles are placed at the height of the second pair of opposite edges. The flows of plasma which, viewed in the plane of panel, make an angle of less than 90°, are then mainly there to make sure that the edges at the height of the corners also receive the desired amount of hydrophobic molecules and do not form weak points in floor covering, and this because a said flow of plasma will be active both on the respective profiled edge and each time on one of the profiled edges adjacent to the respective profiled edge. The nozzles which are placed at the height of the second pair of opposite edges can than for example only eject flows of plasma which have a direction of movement which, viewed in the plane of the panel, make an angle of 90° with the profiled edge of said second pair of opposite edges.

It is clear that, due to special arrangement of nozzles, an accurate start-stop control of the nozzles is not required. Namely, as mentioned above, the nozzles can be active for some time on the adjacent side edges of the panel, also in front of and behind the end points of the actual edge to be covered, i.e. in front of and behind the corner points formed with both adjacent profiled edges.

Further, in a specific embodiment at least one said nozzle is arranged in such a way that it at least operates in such a way that said direction of movement makes an angle with the profiled edge of less than 90 °C and has a component which is opposite to the movement of the said panel or is parallel to the movement of the said panel.

Further, in a specific embodiment, during the plasma treatment a said profiled edge is subsequently subjected to a first and a second flow of plasma with the aid of a first and a second nozzle which are placed along said profiled edge, wherein said second flow of plasma has a direction of movement which makes, viewed in the plane of the panel, an angle of less than 90° to the relevant profiled edge, and preferably has a component which is parallel to the movement of the aforementioned panel. The plasma applied by said second flow of plasma, is less likely to break the bound between hydrophobic molecules and the profiled edge, which have been attached by the first flow of plasma to the panel. Preferably the first flow of plasma, makes, viewed in the plane of the panel, an angle of 90° with the relevant profiled edge.

Preferably each profiled edge is subjected to at least two flows of plasma and preferably at most two flows of plasma. By treating a profiled edge with two flows of plasma, instead of one, hydrophobic molecules can be applied to the panel in faster manner. Treating a profiled edges with three or more flows of plasma could be contra productive since latter flows of plasma could release or destroy/deteriorate formally attached hydrophobic molecules.

In a very preferred embodiment, the substrate comprises at least one layer comprising filled thermoplastic material, being a material comprising a thermoplast such as PVC, or PP, or PE or PET and fillers such as chalk or limestone or talc, and wherein preferably said filled thermoplastic material comprises plasticizers. The plasticizers of said filled thermoplastic material are preferably present in an amount of at most 35 phr, more preferably of at most 25 phr. The plasticizers of said filled thermoplastic material are for example in an amount of less than 15 phr or less than 10 phr or less than 5 phr.

Within the context of the present invention, phr is understood to mean “parts per hundred resin”, i.e. the number of parts by weight of the component per hundred parts by weight of polymer.

The method according to the invention, more specifically the plasma treatment, is very suitable to provide the edges of panels with thermoplastic substrates—such as panels of a heterogeneous vinyl floor covering comprising at least a substrate on the basis of PVC, a décor (for example a printed PVC film), and a transparent synthetic material layer on the basis of PVC-with water-repellent properties to avoid water sipping through the seams of adjacent panels. This because with this plasma treatment, one can attach the hydrophobic molecules to the panels at the height of the surface of these profiled edges. Other methods to provide water-repellent properties rely for example more on penetration, which is of course more difficult with water-resistant materials such as thermoplastic materials. Plasticizers can enhance the wettability of the substrate and/or the top layer, such that hydrophobic molecules can well attach to said profiled edges.

According to some embodiments, the substrate may comprise polyvinyl chloride (PVC). In addition to polymer of vinyl chloride monomer, this PVC may also comprise copolymer composed of vinyl acetate and vinyl chloride. The PVC used typically has a K value (measure of degree of polymerization) of between 50 and 90, preferably between 55 and 70.

Alternative polymers for the substrate are polypropylene and polyethylene, polyurethane, polyester or polyamide.

The substrate may comprise soft, semi-soft or hard polymer. The expression soft polymer (for example soft PVC) is understood to mean a polymer which comprises 40 phr or more than 40 phr of plasticizers. The expression semi-hard or semi-soft polymers is understood to mean a polymer which comprises between 10 and 40 phr of plasticizers, where hard polymer comprises less than or exactly 10 phr of plasticizer.

The substrate may also consist of several layers or sections with different polymers. The substrate could comprise a substrate section under, and preferably directly under, the top layer which is softer than a substrate section situated underneath it. Hydrophobic molecules can well attach to this softer substrate section. Since this softer substrate section is closer to the top layer, this will also be the part of the substrate that will need to be treated by the plasma treatment. For example, the softer substrate section may comprise PVC with a higher plasticizer content than a substrate section situated underneath it, preferably at least 5 phr higher. Thus, for example, the softer substrate section may comprise soft PVC, whereas the substrate section situated underneath it is formed from semi-hard or hard PVC.

In general, in the context of the present invention, plasticizers are inter alia esters of carboxylic acids (for example esters of phthalic acid, isophthalic or terephthalic acid, trimellitic acid and adipic acid), for example diisononyl phthalate (DINP), dioctyl terephthalate (DOTP), diisononyl cyclohexane-1,2-dicarboxylate (DINCH), esters of phosphoric acid, for example triaryl or trialkylaryl phosphates, for example tricresyl phosphate, optionally chlorinated carbohydrates, ethers, polyesters, polyglycols, sulphonamides, or combinations thereof.

In the case of a rigid substrate made of PVC, the substrate comprises hard or semi-hard PVC which, in total, may be between 2 mm and 6 mm thick, for example between 3 mm and 4.5 mm.

The hard or semi-hard PVC preferably comprises up to 15 phr of plasticizer, most preferably between 7 and 10 phr. The hard or semi-hard PVC preferably comprises up to 70 wt % of fillers (compared to the entire weight of the PVC composition).

The substrate may be rigid or flexible, depending on which polymer was used.

In the context of the present invention, flexible means that the products, when a strip of product has been clamped to one side and the other, opposite side can hang freely, will sag under their own weight. Flexible therefore also means that a product will sag more than 35 centimeters per meter of projecting length under its own weight. Preferably, a product will sag more than 40 centimeters per meter of projecting length under its own weight, such as more than 50 centimeters per meter of projecting length. Rigid or stiff on the other hand means that a product will sag less than 35 centimeters per meter of projecting length under its own weight.

The thickness of the substrate, which may as such consist of different layers, is preferably between 3 and 10 mm, most preferably between 3 and 8 mm.

The substrate may be foamed or non-foamed or may comprise foamed and/or non-foamed layers. If it is foamed, the substrate or a portion thereof preferably has a closed foam structure.

The substrate preferably has a density of between 1,8 and 2,1 kg/l in the non-foamed form, for example between 1,85 and 2 kg/l. The substrate of the respective foamed portion thereof preferably has a density of between 0,8 and 1,8 kg/l, such as between 0,85 and 1,5 kg/l in the foamed form.

The substrate may comprise fillers, such as, inter alia, glass fibers, calcium hydroxide (slaked lime), calcium carbonate and calcium hydrogen carbonate, and/or CaMg(CO₃)₂, talcum, or also be lightweight fillers, such as hollow microsphere (for example expanding hollow microspheres such as Expancel). The abovementioned weight percentage (wt %) is expressed as the weight of the filler relative to the weight of the polymer, optionally PVC, in which the filler is comprised. The amount of fillers is preferably between 100 and 300 phr, for example between 150 and 250 phr.

The substrate may furthermore comprise large numbers of other substances, such as pigments and colorants, preservatives, anti-fungi, thermal stabilizers, UV-stabilizers, blowing agents, viscosity control agents, and the like.

In another specific embodiment, the substrate is MDF/HDF, wherein said MDF/HDF preferably comprises wax at a weight percentage of at least 1%. The substrate could also be particle board instead of MDF/HDF. MDF/HDF will take up moisture. Therefore preferably the amount of wax is higher than 1 weight percentage, such that the hydrophobic molecules applied by said plasma do not penetrate to deeply in the MDF/HDF and are still effective. For example the wax percentage can be higher than 1,2 wt %, 1,5 wt %, 2 wt %, 2,5 wt % and even higher than 3 wt %. The wax can be paraffin wax.

The panel can also be a mineral based panel having a mineral based substrate. For example the substrate can be a MgO board, a cement board, etc.

The panel can be a parquet floor panel or a veneer parquet floor panel. The substrate is then a wood-based substrate such as an HDF, wood slats, etc. and the top layer comprises a veneer (a timber layer of less than 2,5 mm) or a timber layer of more than 2,5 mm. Timber layers are prone to take up moisture, certainly at the height of their edges. With the aid of the plasma treatment, said edges can be closed off for water by the hydrophobic molecules which attach to said edges.

In a specific embodiment the method comprises a first fluid treatment, wherein a liquid is applied upon at least a part of a said profiled edges, wherein this first fluid treatment takes place before or after the plasma treatment and wherein preferably, if upon a said profiled edge, the first fluid treatment takes place before the plasma treatment, the plasma treatment takes place while the liquid on the said profiled edge is still in a wet state, and wherein preferably the liquid comprises hydrophobic molecules and a solvent or water. If the method comprises said plasma treatment and said first fluid treatment, there is preferably an overlap such that parts of the profiled edge have both treatments. By having both treatments the water-repellent effect can be enhanced and/or less hydrophobic molecules need to be applied by both treatments/each treatment to have the same water-repellent effect. By having the first fluid treatment taking place before the plasma treatment, the profiled edge can still be in a wet state, which could contribute to a better adhesion between the hydrophobic molecules applied by the plasma treatment to the profiled edges. Alternatively the first liquid treatment could only apply water or a solvent to the profiled edges. One of said treatments, for example only the first fluid treatment or only the plasma treatment, could be applied upon specific places of the profiled edges, for example at the height of the corners between adjacent edges as such to ensure a good water-repellent effect, or for example only the first or the second pair of profiled opposite edges could have both said treatments. It is also possible that each said profiled edge only undergoes one of both said treatments.

If firstly the first liquid treatment is applied, this treatment preferably provided the respective profiled edge with a coating, wherein this coating has a thickness of for example between 1 and 5 micrometer, the plasma treatment then preferably provides a film upon said coating of several nanometers.

The hydrophobic molecules of the plasma treatment are the same molecules or different molecules than the hydrophobic molecules of the first fluid treatment. Preferably they are different molecules. The applied liquid could be solvent-based or water-based. If it is solvent-based, the solvent preferably has a flash point above 30 °C, more preferably above 35 °C, most preferably above 55 °C. The liquid can be applied by one of the following methods:
spraying with for example a nozzle, preferably at a pressure above 3 bar, preferably at a pressure above 5 bar,
applying by means of a transfer roller, or
applying by means of a vacuum technique.

Preferably the first liquid treatment and the plasma treatment are carried out after and in line with the cutting operations—preferably milling operations—for making the coupling parts.

In a specific embodiment the method comprises a second liquid treatment, wherein a lacquer or a paint or a vanish is applied upon at least a part of a said profiled edges, wherein this second liquid treatment takes place before or after the plasma treatment and wherein particularly, if upon a said profiled edge, the second liquid treatment takes place before the plasma treatment, the plasma treatment takes place on said profiled edge while the lacquer or the paint or the varnish on the said profiled edge is still in a wet state and wherein preferably, if the method also comprises said first liquid treatment, said first liquid treatment takes place before the second liquid treatment and even more preferably, if upon a said profiled edge, the second liquid treatment takes place after the first liquid treatment, the second liquid treatment takes place on said profiled edge while the liquid of the first liquid treatment is still in a wet state. It is possible that the method comprises said plasma treatment and said second liquid treatment, but not said first liquid treatment. Said second liquid treatment could enhance the water repellent properties of the panel and/or could enhance the aesthetic appearance of the panel edges (for example the aesthetic appearance of a bevel or imitate a bevel when a colour is applied). If the method comprises said plasma treatment and said second fluid treatment, there could be an overlap such that parts of the profiled edge have both treatments. By having both treatments the water-repellent effect can be enhanced and/or less hydrophobic molecules need to be applied to have the same water-repellent effect. By having the second fluid treatment taking place before the plasma treatment, the profiled edge can still be in a wet state, which could contribute to a better adhesion between the hydrophobic molecules applied by the plasma to the profiled edges. One of said treatments, for example only the second fluid treatment or the plasma treatment, could only be applied upon specific places of the profiled edges, for example at the height of the corners between adjacent edges as such to ensure a good water-repellent effect, or for example only the first or the second pair of profiled opposite edges could have both said treatments. It is also possible that each said profiled edge only undergoes one of both said treatments. The lacquer or the paint or the vanish is preferably waterbased.

The plasma treatment and/or the first liquid treatment and/or the second liquid treatment are preferably carried out in the same continuous process. They can be carried out in a continuous line at a location behind milling machines that form the profiled edges.

Said first liquid treatment and/or the second liquid are preferably performed before the plasma treatment, such that the applied liquid can prevent the hydrophobic molecules to penetrate the substrate and/or the top layer too much. For example the hydrophobic molecules of the plasma treatment can attach to the profiled edges by forming bonds with molecules of the liquid, which in their turn are bond to the panel.

The said first and/or second liquid treatment can be done with the aid of a spraying device, a transfer device—such as a transfer disk or roller—, or a vacuum device. For said first and/or second liquid treatment, a step of blowing away, sucking away, or combined blowing away and sucking away of excessively applied liquid can be present and/or a step of (partial) drying can be present. Also drying can be present for the plasma treatment. Drying can be done by means of one or more IR lamps, preferably by means of one or more HIR lamps (halogen infrared lamps).

In a specific embodiment, at least said first pair of opposite edges comprise a lowered edge surface, for example in the form a square edge, a bevelled edge or a chamfered edge. Such edges are prone to collect water, such that it is important to have a good water repellent properties, such that water cannot go beyond said bevels. The chamfer could not comprise the top layer at least over a part of its surface, so that over at least a part of the surface of the chamfer the substrate gets treated with the plasma treatment and additionally the first liquid treatment and/or the second liquid treatment. The bevel could be a pressed bevel and could thus also comprise the top layer.

Preferably said plasma treatment not only treats the profiled edges, but also the top surface of the panel next to the profiled edges. When the top surface that is located near the seams of adjacent panels has also undergone the plasma treatment, water is even better repelled from the seams. Since with the plasma treatment only small amounts of hydrophobic molecules get attached to surfaces of the panel, these are not visible to the eye and they do not negatively affect the appearance of the panel.

According to a variant, the plasma treatment is not used for the profiled edges or is also used in addition to the profiled edges, wherein this plasma treatment is used to treat the top surface of a floor panel, for example a floor panel of a parquet floor or a veneer parquet floor. With the aid of said plasma treatment as described above, one could also attach hydrophobic molecules to the top surface of a panel as such to enhance the water resistance and/or the water repellent properties of the panel.

For better illustration of the features of the invention, some preferred embodiments are described hereunder, as examples without any limiting character, referring to the appended drawings, in which:

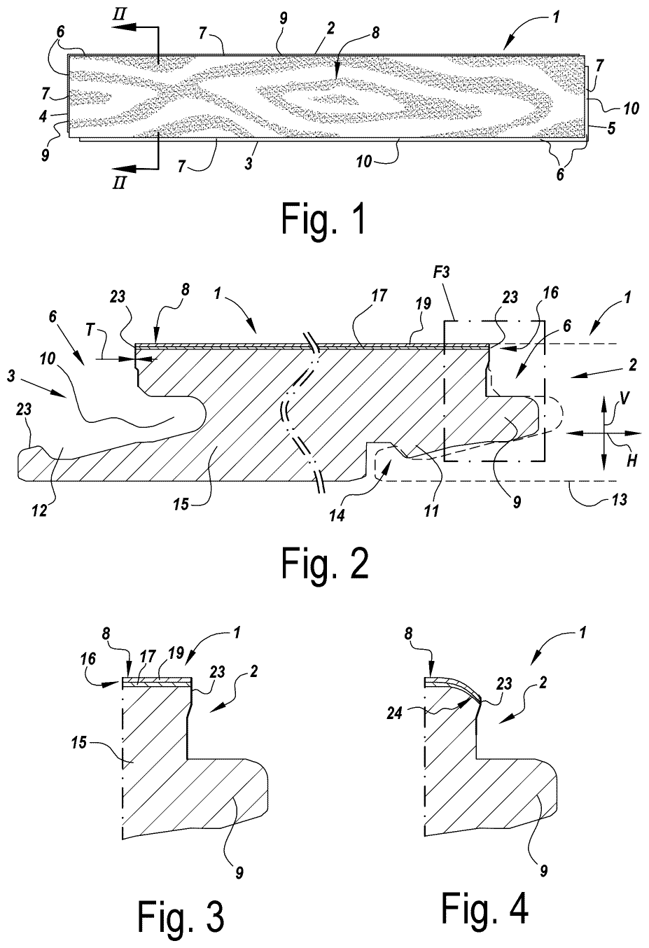

FIG. 1 shows a floor panel obtained on the basis of a method according to the invention;

FIG. 2 shows this floor panel in a cross-section according to line II-II shown in FIG. 1;

FIG. 3 for a variant on a larger scale shows the area indicated by F3 in FIG. 2;

FIG. 4 shows a variation in a similar view;

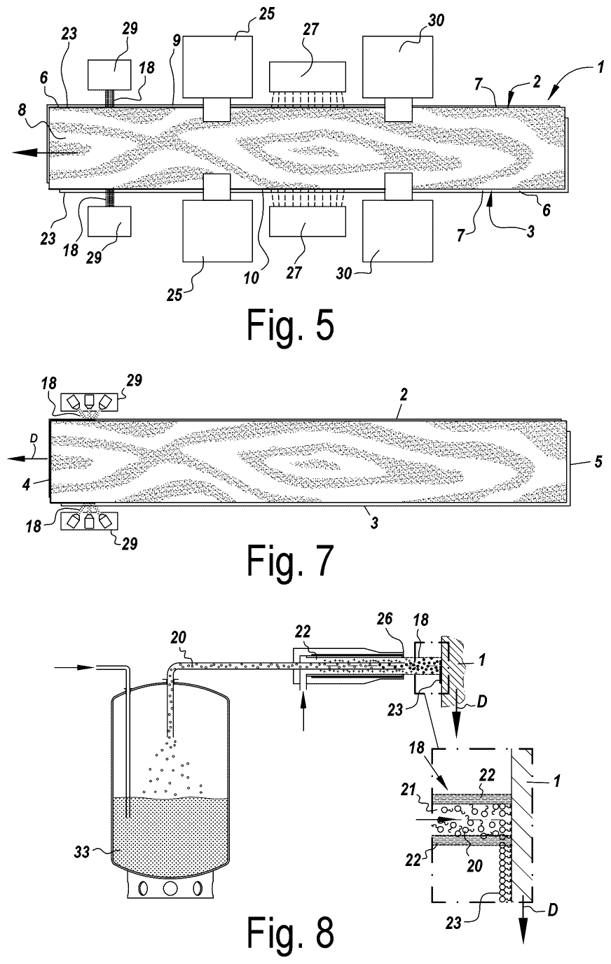

FIG. 5 schematically shows a few steps in a method according to the invention;

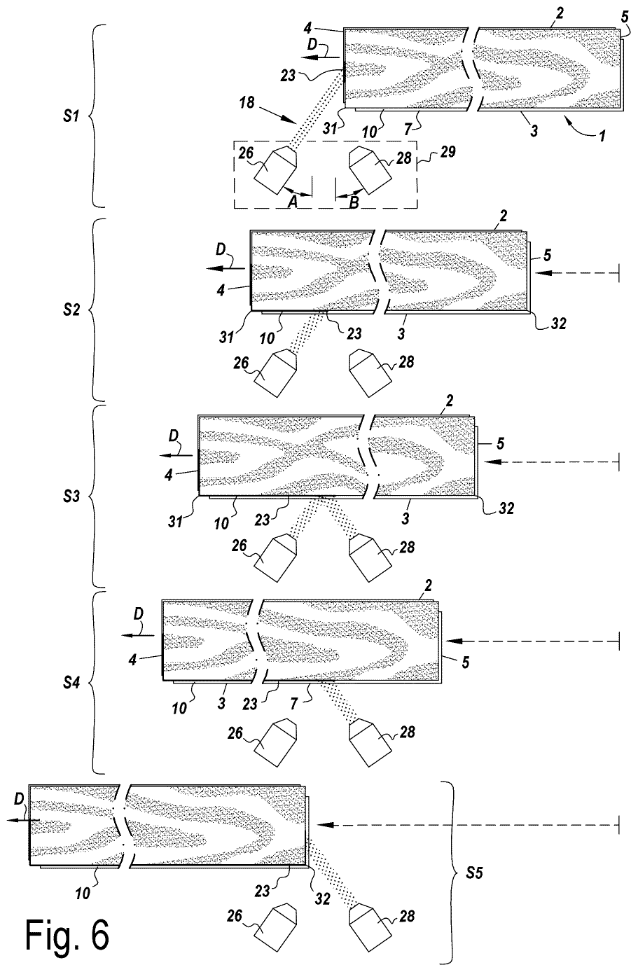

FIG. 6 schematically represent some steps S1 to S5 in a method according to the invention;

FIG. 7 schematically represent possible positions of nozzles used in the plasma treatment step of the invention;

FIG. 8 schematically represents a plasma treatment device used in the plasma treatment step of the invention.

FIG. 1 shows an oblong rectangular floor panel 1 which at two pairs of opposite side edges, 2-3 and 4-5, is provided with profiled edges 6 which include mechanical coupling parts 7.

FIG. 2 clarifies that the used coupling parts 7 allow an interlocking of two such floor panels 1 both in a horizontal direction H as well as in a vertical direction V. For the interlocking in vertical direction V, which is in a direction perpendicular to the top surface 8 of the floor panel 1, the coupling parts 7 shown here are mainly in the form of a tongue 9 and a groove 10. Interlocking in the horizontal direction H, i.e. in a direction perpendicular to the vertical direction V referred to above and in the plane of FIG. 2, is obtained, in this case, by means of locking elements 11-12 in the form of a protrusion 11 on the underside of the tongue 9 and a recess 12 in the lower lip of the groove 10. Upon coupling two such floor panels 1, the locking elements 11-12 cooperate and prevent the floor panels 1 from moving apart. This is shown by the floor panel 1 shown in dashed line 13, where it is clearly visible that there may be an overlap 14 between the not-coupled contours of the groove 10 and the tongue 9, more specifically between the contours of the respective locking elements 11-12. By means of such an overlap 14, a so-called pre-tensioning can be achieved when two floor panels 1 are connected. The concept of pre-tensioning is in itself known from WO 97/47834. Preferably, the used mechanical coupling parts 7 will result in an interlocking free from play of two such floor panels 1 in the aforementioned horizontal direction H and vertical direction V and better still, the coupling parts 7 will result in an interlocking free from play in all directions in the plane determined by the aforementioned directions V and H.

It is clear that the floor panels 1 obtained in the context of the invention may have any shape, such as a rectangular, square, hexagonal or similar shape, as well be provided with any coupling parts 7.

The floor panel 1 shown in FIGS. 1 and 2 is a resilient floor panel 1 containing a substrate 15, where this substrate 15 consists entirely of a filled synthetic material such as filled thermoplastic material, for example PVC filled with chalk with between 15 and 30 weight percentage of PVC and with between 70 and 85 weight percentage chalk and optionally plasticizers. In addition, the aforementioned coupling parts 7 are executed in one-piece with this substrate 15. The floor panel 1 also contains a decorative top layer 16 based on plastic. In this case, the decorative top layer 16 consists of a decorative layer 17 with a printed motif and a wear-resistant layer 19 applied to it, such as a so-called overlay. Both the decorative layer 17 and the overlay 19 comprise PVC.

At least part of the profiled edge 6 is covered with a film 23 which, in this case, includes hydrophobic molecules 20. These hydrophobic molecules 20 are chosen from the list: acrylates such as acrylate esters-, squalene—such as hydrogenated squalene-, siloxanes—such as tetramethyldisiloxane or hexamethyldisiloxane-, polyurethanes, silazanes—such as a polysilazane-, silanes, (modified) alkyd/acryl resins, benzoate esters. The film 23 has a thickness between 1 and 5 nanometer and may or may not be a fully closed film 23.

FIG. 2 shows that the film 23 has a certain thickness T. In this figure as well as in FIGS. 3 and 4 discussed below, this film 23 is schematically shown. It is clear that in reality this film 23 is of such thickness that it is not visible with the eye.

FIG. 3 shows a variation where the film 23 covers the transition between the substrate 15 and the decorative top layer 16 as well as a limited band below the top edge of the floor panel 1. Especially when using a film 23 comprising said hydrophobic molecules 20, a particularly efficient seal can now be achieved, such that it is no longer possible for moisture to penetrate the seams between two interlocked panels 1.

In dashed line S it is shown in FIG. 3 that the film 23 can also extend to the top surface 8 of the floor panel 1. In general, the aim is for the film 23 to cover at least the transition between substrate 15 and the decorative top layer 16.

FIG. 4 shows a variant in which the profiled edge 6 includes at least a lower edge area 24 or chamfer, in this case a bevelled edge. As shown, the film 23 can also be provided on the surface of this lower edge area 24. In the example shown, the decorative top layer 16 extends uninterruptedly from the top surface 8 of the floor panel 1 over the surface of the lower edge area 24.

In the method according to the invention, the profiled edges 6 are subjected to a plasma treatment to apply material to said profiled edges 6 in the form of a film 23 as shown in FIGS. 2 to 4. Said plasma treatment exposes said profiled edges 6 to a plasma beam 18, wherein the plasma beam 18 comprises at least said hydrophobic molecules 20 and a carrier gas, wherein this plasma beam 18 is applied to said profiled edges 6 and attaches said hydrophobic molecules 20 to said profiled edges 6. Optionally, and as shown in FIG. 5, the method according to the invention can also comprise a first liquid treatment to apply a varnish/lacquer/paint to the profiled edges 6 and a second liquid treatment to apply a liquid comprising hydrophobic molecules to the profiled edges 6. If said method also comprises said first and second liquid treatment, a covering is present between a said film 23 and a said profiled edge 6, wherein this covering is formed by said first and second liquid.

FIG. 5 schematically shows a few steps in a method according to the invention with which the floor panel 1 from FIGS. 1 to 4 can be manufactured. This can be done in a continuous line at a location behind milling machines that form the profiled edges 6. The following steps are performed subsequently: the first liquid treatment, a drying step, the second liquid treatment and the plasma treatment. During the first liquid treatment two application devices 30 which could be transfer rollers, vacuum devices or spraying devices, apply a varnish/paint/lacquer upon respective profiled edges 6. During the drying step, two dryers 27 partially dry the applied varnish/paint/lacquer such the profiled edges 6 are still in a wet state when the second liquid treatment starts. Such drying can, for example, take place by radiation such as infrared or ultraviolet radiation. However, it is also possible to use any other technique, such as drying ovens or the technique of supplying hot air. During the second liquid treatment a solvent/water comprising hydrophobic polymeric molecules is sprayed upon the profiled edges 6 with the aid of two spraying devices 25. After this, the plasma treatment takes place and this while the profiled edges 6 are still in a wet state. For the plasma treatment, at least two plasma treatment devices 29, such as plasma torches, are used which each comprise a nozzle 26, 28 which can apply a plasma beam 18 upon a said profiled edge 6. The result is a film 23 comprising said hydrophobic molecules 20 of the plasma, applied upon a coating which comprises a layer of varnish/paint/lacquer and a layer of hydrophobic polymeric molecules.

It is noted that the method shown is a continuous treatment, wherein the floor panel 1 is guided along said devices 30, 27, 25, 29. Such treatments are easy to fit into current production systems for floor panels 1. Here one said profiled edge 6 is treated with one plasma beam 18. However it is possible to apply two or more plasma beams 18 to each said profiled edge 6. The plasma beams 18 shown in FIG. 5 have a direction of movement in the plane of the panel 1 and, viewed in the plane of the panel 1, said direction of movement makes an angle of 90° with the profiled edge 6.

FIG. 6 schematically shows the plasma treatment wherein one profiled edge 6 is guided passed along a first and a second nozzles 26, 28 which each apply a plasma beam 18. As can be seen in FIG. 6, said nozzles 26, 28 are placed in such a way that the direction of movement of the plasma beam 18 is in the plane of the panel 1 and makes, viewed in the plane of the panel 1, an angle A, B of less than 90° with the profiled edge 6. The direction of movement of the plasma beam 18 of the first nozzle 26 has a component which is opposite to the movement of direction D of the panel 1, while the direction of movement of the plasma beam 18 of the second nozzle 28 has a component which is parallel to the movement of direction D of the panel 1. Because of said positions, the nozzles 26, 28 also treat the adjacent side edges 4, 5 of the panel 1 and also the corners 31, 32 between two profiled edges 6 are well treated. Preferably there are also two such nozzles 26, 28 placed on the other side edge 2 of the first pair of opposite side edges 2, 3. The profiled edge 6 of the opposite side edge 2 is then treated in the same way as illustrated by FIG. 6.

The embodiment shown in FIG. 6 is a specific embodiment for the continuous application of plasma on the side edges of panels 1. FIG. 6 shows that the panel 1 is fed in movement direction D. The first nozzle 26 becomes active before the leading corner point 31 passes the first nozzle 26 (see S1 of FIG. 6). The leading adjacent side edge 4 is hereby at least partially treated. S2 of FIG. 6 shows that the first nozzle 26 remains active on the actual side edge 3 to be treated. S3 and S4 of FIG. 6 show that the second nozzle 28 becomes active on the side edge 3 and takes over from the first nozzle 26, preferably in an overlapping manner. S5 of FIG. 6 shows that the second nozzle 28 remains active after the panel 1 with its trailing corner point 32 has passed the second nozzle 28. In this way, the trailing side edge 5 can also be provided at least in part with the film 23.

It is clear that by means of the method illustrated in FIG. 6 also at the leading corner point 31 and the trailing corner point 32, a qualitative film 23 can be obtained.

In addition, it is clear from FIG. 6 that the starting and stopping moment of the plasma treatment by means of the first nozzle 26 and the second nozzle 28 need not necessarily be accurate.

In an alternative embodiment, a said first and/or second liquid treatment could be applied to all side edges, and the said plasma treatment could (only) be applied at the height of the corners, such that each trailing corner point ant each leading corner point has sufficient water-repellent properties.

FIG. 7 illustrates which positions the nozzles of a plasma treatment device 29 can take up with regard to the panel 1. Here the plasma treatment devices 29 are positioned along the long edges 2, 3, however (additional) plasma treatment devices 29 can also be positioned along the short edges 4, 5. The plasma beams 18 have a direction of movement in the plane of the panel 1 and, viewed in the plane of the panel 1, can make an angle of 90° with the profiled edge 6 or can make an angle of less than 90° with the profiled edge 6.

FIG. 8 schematically illustrates how a plasma treatment device 29, such as a plasma torch, functions and this when a panel 1 is moved along a nozzle 26 of said plasma treatment device 29 according to a direction of movement D. The hydrophobic molecules 20 and a carrier gas are brought together in an atomizer 33. With the aid of the carrier gas, the hydrophobic molecules 20 are brought to a treatment region in which the carrier gas and the hydrophobic molecules 20 are brought in the plasma state. Because of said plasma state, the hydrophobic molecules 20 get activated—this is indicated with a bold line or a hook in the detailed view of the plasma beam 18—. The plasma beam 18 comprises an inner flow 21 comprising the activated hydrophobic molecules 20 and the carrier gas, and an outer flow 22, formed by a protective gas, which surround the inner flow 21. The activated hydrophobic molecules 20 form a covalent bound with the surface of the profiled edge 6 of the panel 1. Said surface of the profiled edge 6 also gets activated by the plasma beam 18, such that said covalent bound can be easily made.

The present invention is by no means limited to the embodiments described above, but such panels and methods can be realized without going beyond the framework of the present invention.

1.-25. (canceled)

26. A method for manufacturing panels, wherein the panels are rectangular, either square or oblong, wherein the panels comprise a substrate and a top layer;
wherein the panels are provided with a first pair and a second pair of opposite edges, of which at least said first pair of opposite edges are profiled to form profiled edges which at least comprise coupling parts,
wherein at least one of said profiled edges are subjected to a plasma treatment to apply material to said profiled edges wherein said plasma treatment exposes said profiled edges to a plasma,
wherein the plasma comprises at least hydrophobic molecules and a carrier gas,
wherein this plasma is applied to said profiled edges and attaches said hydrophobic molecules to said profiled edges.

27. The method as in claim 26, wherein the applied plasma has a temperature of at most 100 °C.

28. The method as in claim 26, wherein the applied plasma comprises an inner flow comprising said hydrophobic molecules and said carrier gas, and an outer flow surrounding said inner flow,
wherein said outer flow comprises a protective gas.

29. The method as in claim 28, wherein the inner flow of the plasma is a is beam applied towards and upon the profiled edges according to a direction of movement,
wherein said direction of movement is in the plane of the panel,
wherein the maximum dimension of said inner flow according to a direction perpendicular to the plane of the panel is at least the same as the height of the part of the respective profiled edge that needs to be treated.

30. The method as in claim 26, wherein the carrier gas and/or the protective gas are chosen from the list: nitrogen gas (N2), helium gas (He) Argon gas (Ar), oxygen gas (O2), heliox gas or air.

31. The method as in claim 26, wherein said hydrophobic molecules comprise an aliphatic hydrocarbon group with between 6 and 34 carbon atoms.

32. The method as in claim 26, wherein said hydrophobic molecules are chosen from the list consisting of: acrylates—such as acrylate esters-, squalene—such as hydrogenated squalene-, siloxanes—such as tetramethyldisiloxane or hexamethyldisiloxane-, polyurethanes, silazanes—such as a polysilazane-, linear aliphatic alkanes or branched aliphatic alkanes.

33. The method as in claim 26, wherein, with the aid of this plasma treatment, between 1 mg and 50 mg hydrophobic molecules are applied per m2 panel.

34. The method as in claim 26, wherein the hydrophobic molecules are atomized and activated, and
wherein the plasma treatment activates the profiled edges at the height of the substrate and/or the top layer, such that the plasma treatment causes a covalent bond between the hydrophobic molecules and the substrate and/or the top layer.

35. The method as in claim 26, wherein to form the plasma no solvents are used.

36. The method as in claim 26, wherein the hydrophobic molecules are free from fluor.

37. The method as in claim 26, wherein the plasma treatment takes place at atmospheric pressure and is done with the aid of a plasma torch.

38. The method as in claim 26, wherein said plasma is applied as one or more flows of plasma, and this with the aid of respectively one or more nozzles.

39. The method as in claim 38, wherein at least one said nozzle is arranged in such a way that it at least operates in such a way that said direction of movement makes an angle with the profiled edge of less than 90 °C and has a component which is opposite to the movement of the said panel or is parallel to the movement of the said panel.

40. The method as in claim 38, wherein, during the plasma treatment a said profiled edge is subsequently subjected to a first and a second flow of plasma with the aid of a first and a second nozzle which are placed along the path of movement of a said panel and towards a said profiled edge,
wherein said second flow of plasma has a direction of movement which makes, viewed in the plane of the panel, an angle of less than 90 ° to the relevant profiled edge.

41. The method as in claim 26, wherein each profiled edge is subjected to at least two flows of plasma

42. The method as in claim 26, wherein the method comprises a first fluid treatment,
wherein a liquid is applied upon at least a part of a said profiled edges,
wherein this first fluid treatment takes place before or after the plasma treatment.

43. The method as in claim 42, wherein the hydrophobic molecules of the plasma treatment are the same molecules or different molecules than the hydrophobic molecules of the first fluid treatment.

44. The method as in claim 26, wherein the method comprises a second liquid treatment,
wherein a lacquer or a paint or a vanish is applied upon at least a part of a said profiled edges,
wherein this second liquid treatment takes place before or after the plasma treatment.

45. The method as in claim 26, wherein at least said first pair of opposite edges comprise a lowered edge surface, for example in the form a square edge, a bevelled edge or a chamfered edge.
